(19) United States
(12) Patent Application Publication
(10) Pub. No.: US 2020/0377975 A1
(43) Pub. Date: Dec. 3, 2020

(54) PARTICLE-REINFORCED ALUMINUM COMPOSITE MATERIAL, PRESSURE-RESISTANT COMPONENT USING SAME, AND METHOD FOR MANUFACTURING PRESSURE-RESISTANT COMPONENT

(71) Applicant: AISIN SEIKI KABUSHIKI KAISHA, Kariya-shi (JP)

(72) Inventors: Hajime MINAKI, Kariya-shi (JP); Yuki WATANABE, Kariya-shi (JP); Akihito KAWAMURA, Kariya-shi (JP)

(73) Assignee: AISIN SEIKI KABUSHIKI KAISHA, Kariya-shi (JP)

(21) Appl. No.: 16/884,191

(22) Filed: May 27, 2020

(30) Foreign Application Priority Data
May 31, 2019 (JP) 2019-102573
Mar. 24, 2020 (JP) 2020-052928

(51) Int. Cl. C22C 21/04; C22F 1/043; F16D 65/00

(52) U.S. Cl. CPC C22C 21/04; C22F 1/043; F16D 55/22; F16D 2200/003; F16D 65/0068

(57) ABSTRACT

A particle-reinforced aluminum composite material includes: a base material formed of an aluminum alloy; and reinforcing particles dispersed in the base material. The reinforcing particles include a main component represented by MgAl₂O₄ and aluminum.

### CROSS REFERENCE TO RELATED APPLICATIONS

This application is based on and claims priority under 35 U.S.C. § 119 to Japanese Patent Applications 2019-102573 and 2020-052928, filed on May 31, 2019 and Mar. 24, 2020, respectively, the entire content of which is incorporated herein by reference.

### TECHNICAL FIELD

This disclosure relates to a particle-reinforced aluminum composite material, a pressure-resistant component using the same, and a method for manufacturing a pressure-resistant component.

### BACKGROUND DISCUSSION

Particle-reinforced aluminum composite materials formed by adding hard particles (reinforcing particles) formed of an inorganic material or the like to an aluminum composite material have been developed. For example, JP 2007-291450A discloses a particle-reinforced aluminum composite material containing spinel particles as the reinforcing particles. The particle-reinforced aluminum composite material described in JP 2007-291450A is manufactured by adding metal oxide particles other than aluminum oxide and magnesium to molten aluminum or a molten aluminum alloy and stirring the mixture. When the metal oxide particles and magnesium are added to the molten aluminum or the molten aluminum alloy, the metal oxide, magnesium, and aluminum react with each other in the molten metal to generate spinel particles. The generated spinel particles are dispersed as reinforcing particles in an aluminum alloy base material.

The particle-reinforced aluminum composite material described in JP 2007-291450A includes spinel particles having extremely high hardness as the reinforcing particles and thus has a high mechanical strength, but has poor machinability.

A need thus exists for a particle-reinforced aluminum composite material, a pressure-resistant component using the same, and a method for manufacturing a pressure-resistant component using the same, which are not susceptible to the drawback mentioned above.

### SUMMARY

An aspect of this disclosure provides a particle-reinforced aluminum composite material including a base material formed of an aluminum alloy and reinforcing particles dispersed in the base material, in which the reinforcing particles include a main component represented by MgAl₂O₄ and aluminum.

### BRIEF DESCRIPTION OF THE DRAWINGS

The foregoing and additional features and characteristics of this disclosure will become more apparent from the following detailed description considered with the reference to the accompanying drawings, wherein:

FIG. 1 is a schematic view of a manufacturing device for manufacturing a particle-reinforced aluminum composite material;

FIG. 2 is a SEM image of silicon dioxide particles charged into a molten aluminum alloy in Example 1;

FIG. 3 is a SEM image (1000 times) of a sample S1 according to Example 1;

FIG. 4 is a SEM image (10000 times) of the sample S1 according to Example 1;

FIG. 5A is an enlarged SEM image (40000 times) of a part of reinforcing particles;

FIG. 5B is an enlarged SEM image (40000 times) of a part of the reinforcing particles;

FIG. 6 is a SEM image (200 times) of a sample S9 according to Example 3;

FIG. 7 is a SEM image (200 times) of a sample S10 according to Example 3;

FIG. 8 is a graph showing a relationship between a particle content rate and Young's modulus;

FIG. 9 is a schematic diagram of a friction stir tool used in Example 4 and an aluminum composite plate being friction-stirred;

FIG. 10 is photographic images of a cross section of a structure according to Example 3 and a cross section of a structure according to Example 4 observed with a metallographic microscope;

FIG. 11A shows a measurement result of a particle size distribution of a crystallized substance according to Example 3;

FIG. 11B shows a measurement result of a particle size distribution of a crystallized substance according to Example 4;

FIG. 12 shows tensile test results of tensile test pieces according to Example 3 and Example 4;

FIG. 13 shows amounts of elongation of the tensile test pieces according to Example 3 and Example 4;

FIG. 14 shows tensile test results of tensile test pieces according to Example 3 and Example 5;

FIG. 15 shows amounts of elongation of the tensile test pieces according to Example 3 and Example 5;

FIG. 16 is a schematic view of a caliper body as a pressure-resistant component according to Example 6; and

FIG. 17 is a schematic cross-sectional view of a brake device into which the caliper body of FIG. 16 is assembled.

### DETAILED DESCRIPTION

A particle-reinforced aluminum composite material disclosed here includes a base material forming a matrix and reinforcing particles dispersed in the base material.

The base material is formed of an aluminum alloy. As components other than aluminum included in the aluminum alloy base material, any one or a plurality of magnesium (Mg), silicon (Si), iron (Fe), copper (Cu), manganese (Mn), zinc (Zn), and titanium (Ti) can be exemplified. Among these, for example, an aluminum alloy containing at least magnesium and silicon is preferred as the base material disclosed here.

The reinforcing particles include a main component represented by MgAl₂O₄ and aluminum (metallic aluminum). Here, the main component refers to a component that forms the majority of the reinforcing particles and exhibits the main properties of the reinforcing particles. In a case where all of the components are MgAl₂O₄, the reinforcing particles are spinel particles. Therefore, the reinforcing particles disclosed here can be said to be spinel particles into which aluminum is partially mixed. Aluminum is preferably mixed into the reinforcing particles so as to adhere to the main component (spinel).

The hardness of the spinel particles is extremely high, and thus the mechanical strength of an aluminum composite material containing the spinel particles is high. However, conversely, the machinability is poor. In contrast, the reinforcing particles disclosed here are spinel particles into which aluminum having low hardness is mixed, and thus the hardness of the reinforcing particles disclosed here is slightly lower than the hardness of the spinel particles. Therefore, the decoupling property of the reinforcing particles improves, and, consequently, the machinability of the particle-reinforced aluminum composite material disclosed here is improved. In addition, the majority of the reinforcing particles are formed of MgAl₂O₄ that is the main component, and thus the mechanical strength of the aluminum composite material in which the reinforcing particles disclosed here are dispersed in the base material is low compared with the mechanical strength of an aluminum composite material in which the spinel particles are dispersed in the base material, but the mechanical strength does not decrease significantly. Therefore, according to the particle-reinforced aluminum composite material disclosed here, the machinability is improved without significantly decreasing the mechanical strength compared with the aluminum composite material containing spinel particles.

The reinforcing particles preferably contains 40 wt % or more of aluminum. The composition of the spinel particles is represented by MgAl₂O₄, and, in this case, the content rate of aluminum in the spinel particles is theoretically 38 wt %. Therefore, in a case where the reinforcing particles contains 40 wt % or more of aluminum, the reinforcing particles include 2 wt % or more of metallic aluminum. Therefore, it is possible to form the reinforcing particles to include MgAl₂O₄ as the main component and 2 wt % or more of aluminum. In this case, the reinforcing particles preferably include 40 wt % or more and 50 wt % or less of aluminum.

In addition, the reinforcing particles disclosed here preferably contain 16 wt % or less of magnesium. The content rate of magnesium in the spinel particles is theoretically 16.9 wt %. Therefore, when the content rate of magnesium is suppressed to be 16 wt % or less, the generation of MgAl₂O₄ only as all of the reinforcing particles is prevented, and metallic aluminum is partially mixed into the reinforcing particles. In this case, the reinforcing particles preferably include 5 wt % or more and 16 wt % or less of magnesium.

The reinforcing particles disclosed here more preferably include 40 wt % or more and 50 wt % or less of aluminum and 5 wt % or more and 16 wt % or less of magnesium. Far still more preferably, the reinforcing particles disclosed here include 40 wt % or more and 50 wt % or less of aluminum, 5 wt % or more and 16 wt % or less of magnesium, 40 wt % or more and 50 wt % or less of oxygen, and an inevitable impurity, and the total mass concentration thereof is 100 wt %.

In addition, the base material preferably contains more than 12.6 wt % of silicon (Si). In an Al (aluminum)-Si (silicon)-based alloy, the concentration of Si at the eutectic point of Al and Si is 12.6 wt %. In a case where the base material includes a higher concentration of Si than the concentration of Si at the eutectic point, hard β (Si) particles crystallize in a cooling process of molten aluminum alloy during the manufacturing of the particle-reinforced aluminum composite material. The Young's modulus of the β (Si) particles is as large as approximately 185 GPa. Therefore, it is possible to enhance the stiffness of the particle-reinforced aluminum composite material with the β (Si) particles crystallized in the base material and the reinforcing particles dispersed in the base material. Additionally, it is possible to decrease the linear expansion coefficient of the particle-reinforced aluminum composite material.

In addition, it is known that, when the content rate of silicon in the base material exceeds 12.6 wt %, the fluidity of the molten aluminum alloy improves in the manufacturing process of the particle-reinforced aluminum composite material. Therefore, it is possible to enhance the castability at the time of casting the particle-reinforced aluminum composite material disclosed here. However, when the content rate of silicon in the base material exceeds 20 wt %, the fluidity of the molten aluminum alloy degrades, and the workability of the molded aluminum composite material deteriorates. Therefore, the content rate of silicon in the base material is preferably more than 12.6 wt % and 20 wt % or less.

In addition, the average particle diameter (median diameter) of the reinforcing particles dispersed in the base material is preferably 10 μm or more. JP 2007-291450A describes that the diameters of spinel particles dispersed in an aluminum alloy are 0.2 μm. When the diameters of the reinforcing particles dispersed in the base material are extremely small as described above, the improvement of the wear resistance cannot be expected. Therefore, when the average particle diameter of the reinforcing particles dispersed in the base material of the particle-reinforced aluminum composite material is adjusted to 10 μm or more, it is possible to improve the wear resistance.

In addition, the average particle diameter (median diameter) of the crystallized substance including the β (Si) particles included in the base material is preferably 5 μm or less. Furthermore, the maximum particle diameter of the crystallized substance including the β (Si) particles included in the base material is preferably 50 μm or less. In a case where the average particle diameter (median diameter) of the crystallized substance including the β (Si) particles included in the base material is 5 μm or less, and the maximum particle diameter of the crystallized substance including the β (Si) particles is 50 μm or less, that is, in a case where the crystallized substance including the β (Si) particles in the base material is refined, it is possible to enhance the tensile strength and ductility of the aluminum composite material.

The particle-reinforced aluminum composite material disclosed here can be manufactured through a raw material particle charging step and a reinforcing particle generation step.

In the raw material particle charging step, powder composed of silicon dioxide particles is charged into a molten aluminum alloy including magnesium. The particle diameter of the silicon dioxide particles to be charged is preferably approximately 10 μm to 50 μm. Particularly, the average particle diameter (median diameter) of the silicon dioxide particles to be charged is preferably 10 μm or more. In addition, as a method for charging the silicon dioxide particles, it is possible to employ a method in which the powder is discharged together with a carrier gas (for example, nitrogen gas) so as to be blown toward the molten metal surface of the molten aluminum alloy stored in a storage tank from a supply device capable of supplying the powder composed of the silicon dioxide particles. When the powder composed of the silicon dioxide particles is blown to the molten aluminum alloy as described above, the silicon dioxide particles are uniformly dispersed in the molten aluminum alloy.

In the reinforcing particle generation step, the silicon dioxide particles charged into the molten aluminum alloy in the raw material particle charging step with magnesium and aluminum, which are the components of the molten aluminum alloy, are reacted with each other, thereby converting the silicon dioxide particles into the reinforcing particles including the main component represented by MgAl₂O₄ and aluminum. In this case, the molten aluminum alloy into which the silicon dioxide particles are charged in the raw material particle charging step is stirred and held at a predetermined temperature (for example, 700° C.) for a predetermined time (for example, 120 minutes). Therefore, in the molten aluminum alloy, silicon dioxide (SiO₂) is reduced, silicon is released into the molten alloy, and aluminum and magnesium react with oxygen, whereby the silicon dioxide particles are converted to particles including MgAl₂O₄ as the main component. A small amount of metallic aluminum is mixed into the particles changed as described above, thereby generating the reinforcing particles.

In addition, in the above-described reinforcing particle generation step, silicon dioxide is reduced, and thus silicon is released into the molten aluminum alloy. Therefore, the molten aluminum alloy includes silicon. When the final content rate of silicon at this time exceeds 12.6 wt %, a crystallized substance including the β (Si) particles crystallizes in the cooling process of the molten aluminum alloy. Therefore, after the end of cooling, the β (Si) particles crystallize in the base material. When the β (Si) particles crystallize in the base material, it is possible to improve the stiffness of the aluminum composite material as described above.

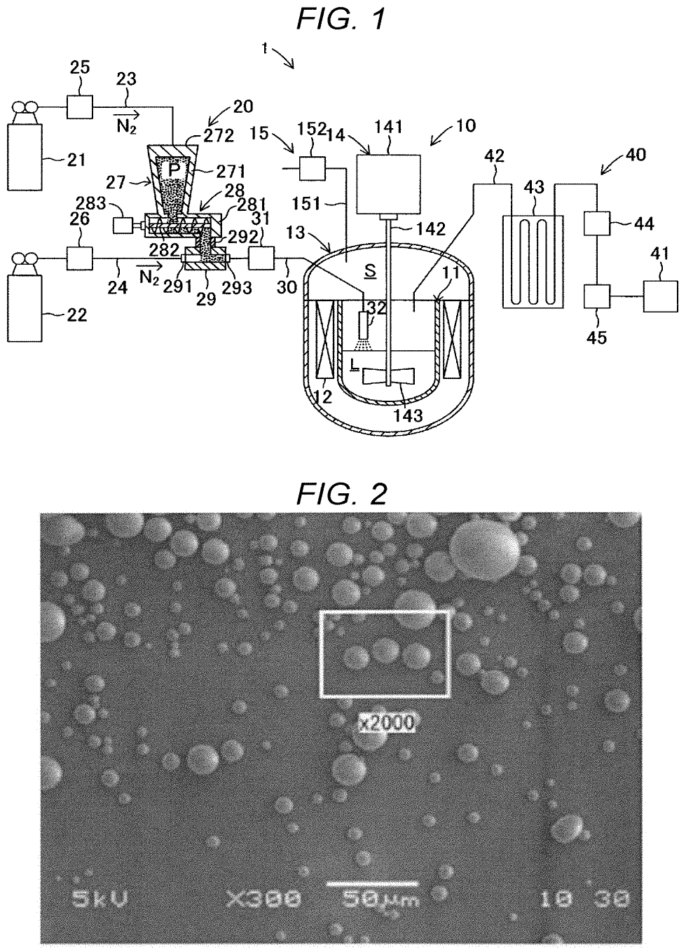

Next, a specific example of a method for manufacturing a particle-reinforced aluminum composite material disclosed here and reinforcing particles included in a particle-reinforced aluminum composite material manufactured by the manufacturing method will be described. FIG. 1 is a schematic view of a manufacturing device for manufacturing the particle-reinforced aluminum composite material. As shown in FIG. 1, a manufacturing device 1 includes a molten metal storage portion 10, a particle supply device 20, and a decompression device 40.

The molten metal storage portion 10 has a storage tank 11 configured to store a molten aluminum alloy, a heater 12 such as an electric heater configured to heat the storage tank 11, an accommodation container 13 capable of air-tightly accommodating the storage tank 11 in a decompressed state, a stirrer 14 configured to stir a molten aluminum alloy L stored in the storage tank 11, and a relief valve unit 15 for releasing the internal pressure of the accommodation container 13 to the atmosphere.

The storage tank 11 is configured using a bottomed cylindrical crucible or the like. The heater 12 is laid around the outer circumference of the storage tank 11. The raw material of the molten aluminum alloy L is charged into the storage tank 11. The charged raw material is heated with the heater 12 and melted. Therefore, the molten aluminum alloy L is stored in the storage tank 11.

The accommodation container 13 is a closed container configured so as to be capable of maintaining a decompressed state of the internal space. The storage tank 11 and the heater 12 are disposed in the internal space of the accommodation container 13. When the storage tank 11 and the heater 12 are disposed in the accommodation container 13, an upper space S is formed above the storage tank 11 as shown in FIG. 1.

The stirrer 14 has a motor 141, a stirring rod 142 that is coaxially connected to the output shaft of the motor 141 and rotates around the axis in association with the rotation of the motor 141, and a stirring blade 143 attached to the tip of the stirring rod 142. The motor 141 is provided above the accommodation container 13. The stirring rod 142 runs downward into the accommodation container 13 from the upper wall portion of the accommodation container 13 as shown in FIG. 1. In addition, the tip portion of the stirring rod 142 is inserted into the molten aluminum alloy L stored in the storage tank 11 in the accommodation container 13 together with the stirring blade 143. When the motor 141 is driven in this state, the stirring blade 143 rotates in the molten aluminum alloy L. Therefore, the molten aluminum alloy L is stirred.

The relief valve unit 15 has a relief pipe 151 and a relief valve 152. One end of the relief pipe 151 communicates with the upper space S in the accommodation container 13, and the other end of the relief pipe 151 communicates with the atmosphere. The relief valve 152 is a normally-closed valve interposed in the middle of the relief pipe 151 and is opened, for example, after the completion of the reinforcing particle generation step described below to open the space in the accommodation container 13 to the atmosphere.

The particle supply device 20 has a first nitrogen gas cylinder 21, a second nitrogen gas cylinder 22, a first gas pipe 23, a second gas pipe 24, a first gas flow rate adjustment valve 25, a second gas flow rate adjustment valve 26, a particle supply tank 27, a fixed amount supply device 28, a mixing device 29, a powder transport pipe 30, a powder flow rate adjustment valve 31, and an injection nozzle 32.

Compressed nitrogen gas is sealed in the first nitrogen gas cylinder 21 and the second nitrogen gas cylinder 22. The first nitrogen gas cylinder 21 is connected to one end of the first gas pipe 23 and is configured to be capable of supplying the inside nitrogen gas to the first gas pipe 23. The second nitrogen gas cylinder 22 is connected to one end of the second gas pipe 24 and is configured to be capable of supplying the inside nitrogen gas to the second gas pipe 24. In addition, the first gas flow rate adjustment valve 25 is interposed in the first gas pipe 23. The flow rate of the nitrogen gas flowing through the first gas pipe 23 is adjusted with the first gas flow rate adjustment valve 25. In addition, the second gas flow rate adjustment valve 26 is interposed in the second gas pipe 24. The flow rate of the nitrogen gas flowing through the second gas pipe 24 is adjusted with the second gas flow rate adjustment valve 26.

The particle supply tank 27 is connected to the other end of the first gas pipe 23. The particle supply tank 27 has a tank main body 271 having an internal space and a lid 272. The tank main body 271 is formed in a truncated cone shape so that the diameter decreases downward and is open at the upper end and the lower end. The lid 272 is attached to the upper end of the tank main body 271, thereby closing the upper end opening of the tank main body 271. In addition, the other end of the first gas pipe 23 is open to the internal space of the tank main body 271 through the lid 272. In the tank main body 271 of the particle supply tank 27, powder P composed of a silicon dioxide particle group is stored.

The fixed amount supply device 28 is connected to the lower end of the tank main body 271 of the particle supply tank 27. The fixed amount supply device 28 has a long and narrow container main body 281 having an internal space, a transport screw 282 disposed in the internal space of the container main body 281 along the longitudinal direction of the container main body 281, and a motor 283 configured to rotate the transport screw 282 around the axis. An upper opening communicating with the lower end of the tank main body 271 of the particle supply tank 27 is formed in the upper portion of the container main body 281, and a lower opening communicating with the mixing device 29 is formed in the lower portion of the container main body 281. The powder P stored in the tank main body 271 of the particle supply tank 27 is supplied into the container main body 281 through the upper opening of the container main body 281. In addition, the operation of the motor 283 rotates the transport screw 282, thereby transporting the powder P supplied into the container main body 281 rightward in FIG. 1. In addition, the powder P is supplied to the mixing device 29 from the lower opening of the container main body 281 at a constant flow rate.

The mixing device 29 is formed in a box shape having an internal space. In the mixing device 29, a gas inlet port 291 to which the other end of the second gas pipe 24 is connected, a powder inlet port 292 communicating with the lower opening provided in the container main body 281 of the fixed amount supply device 28, and an outlet port 293 are formed. In addition, the outlet port 293 of the mixing device 29 is connected to one end of the powder transport pipe 30. The powder transport pipe 30 runs toward the inside of the accommodation container 13 as shown in FIG. 1. In addition, the other end of the powder transport pipe 30 is connected to the injection nozzle 32 in the inside of the accommodation container 13. In addition, the powder flow rate adjustment valve 31 is interposed in the middle of the powder transport pipe 30.

The injection nozzle 32 is formed in a long shape and is disposed such that the longitudinal direction coincides with the vertical direction as shown in FIG. 1. The injection nozzle 32 is installed inside the storage tank 11 disposed in the accommodation container 13 and above the molten metal surface of the molten aluminum alloy L stored in the storage tank 11. The injection nozzle 32 is formed in a tubular shape so as to have an internal space, and the other end of the powder transport pipe 30 is connected to the upper end of the injection nozzle. In addition, a discharge outlet is formed at the lower end of the injection nozzle 32. In addition, the injection nozzle 32 is disposed such that the discharge outlet of the injection nozzle 32 faces the molten metal surface of the molten aluminum alloy stored in the storage tank 11.

The decompression device 40 has a vacuum pump 41, a pipe 42, a gas cooler 43, a particle filter 44, and an on/off valve 45. One end of the pipe 42 is connected to the vacuum pump 41, and the other end of the pipe 42 is inserted into the internal space of the accommodation container 13. The gas cooler 43, the particle filter 44, and the on/off valve 45 are respectively interposed in the middle of the pipe 42 from the other end side. The gas cooler 43 is configured to be capable of cooling gas flowing in the pipe 42. The particle filter 44 collects the powder P flowing in the pipe 42.

In a case where the particle-reinforced aluminum composite material is manufactured using the manufacturing device 1 having the above-described configuration, first, a molten metal generation step is carried out. In the molten metal generation step, a bulk (ingot) of an aluminum alloy containing magnesium is charged into the storage tank 11, and then the heater 12 is operated. Therefore, the aluminum alloy is melted, and the molten aluminum alloy L is stored in the storage tank 11.

Next, a decompression step is carried out. In the decompression step, the on/off valve 45 is opened, and the vacuum pump 41 is operated. Therefore, the internal space of the accommodation container 13 is exhausted, and the internal pressure of the accommodation container 13 is set to a predetermined low pressure.

When the internal pressure of the accommodation container 13 is set to the predetermined low pressure by carrying out the decompression step, the raw material particle charging step is carried out. In the raw material particle charging step, nitrogen gas is supplied from the first nitrogen gas cylinder 21 to the particle supply tank 27 through the first gas pipe 23, and nitrogen gas is supplied from the second nitrogen gas cylinder 22 to the mixing device 29 through the second gas pipe 24. At this time, the flow rate of the nitrogen gas flowing through the first gas pipe 23 is adjusted with the first gas flow rate adjustment valve 25, and the flow rate of the nitrogen gas flowing through the second gas pipe 24 is adjusted with the second gas flow rate adjustment valve 26.

The nitrogen gas supplied from the first nitrogen gas cylinder 21 to the particle supply tank 27 is introduced into the fixed amount supply device 28 together with the powder P in the particle supply tank 27. In the fixed amount supply device 28, the powder P is supplied at a constant flow rate to the mixing device 29 together with the nitrogen gas by rotating the transport screw 282. In this mixing device 29, the powder P merges with the nitrogen introduced into the mixing device 29 from the second nitrogen gas cylinder 22. In addition, the powder P is supplied from the outlet port 293 of the mixing device 29 to the injection nozzle 32 in the accommodation container 13 through the powder transport pipe 30 together with the nitrogen gas as a carrier gas. At this time, the flow rate of the powder P flowing in the powder transport pipe 30 and supplied to the injection nozzle 32 is adjusted with the powder flow rate adjustment valve 31.

The powder P supplied to the injection nozzle 32 is injected from the discharge outlet formed at the lower end of the injection nozzle 32. The discharge outlet of the injection nozzle 32 is oriented downward so as to face the molten metal surface of the molten aluminum alloy L in the storage tank 11 as described above, and thus the powder P injected from the discharge outlet of the injection nozzle 32 is blown to the molten aluminum alloy L so as to be driven into the molten aluminum alloy L in the storage tank 11. The powder P composed of the silicon dioxide particle group is charged into the molten aluminum alloy L as described above.

While a predetermined amount of the powder P is charged into the molten aluminum alloy L in the raw material particle charging step, the molten aluminum alloy L is stirred with the stirrer 14 and held at a predetermined temperature for a predetermined time. At this time, the reinforcing particle generation step is executed. In the reinforcing particle generation step, a reduction reaction described below proceeds from the surfaces of the silicon dioxide particles forming the powder P in the molten aluminum alloy L.

2SiO₂+2Al+Mg→MgAl₂O₄+2Si

Due to the above-described reduction reaction, the silicon dioxide particles forming the powder P react with aluminum and magnesium in the molten aluminum alloy, whereby silicon is released from the silicon dioxide particles into the molten aluminum alloy, and the silicon dioxide particles change into particles containing MgAl₂O₄ as the main component. In addition, in the generation process of these particles, aluminum permeates into the particles, whereby reinforcing particles containing MgAl₂O₄ as the main component and aluminum mixed thereinto are generated. The reinforcing particles including the main component represented by MgAl₂O₄ and aluminum are generated in the reinforcing particle generation step as described above. The generated reinforcing particles are uniformly dispersed in the molten aluminum alloy L by stirring the molten aluminum alloy L with the stirrer 14.

After that, the stirrer 14 is stopped, and the heating with the heater 12 is stopped, thereby cooling the molten aluminum alloy in the storage tank 11. Alternatively, the molten aluminum alloy in the storage tank 11 is poured into a cooling mold, thereby cooling the molten aluminum alloy. Therefore, the molten aluminum alloy L solidifies, and the particle-reinforced aluminum composite material according to the present embodiment is manufactured.

The particle-reinforced aluminum composite material manufactured as described above has the base material formed of an aluminum alloy and the reinforcing particles dispersed in the base material. In addition, as described above, the reinforcing particles include the main component represented by MgAl₂O₄ and aluminum. The content rate of aluminum included in the reinforcing particles is higher than the content rate (38 wt %) of Al in MgAl₂O₄ particles (spinel particles).

In addition, the content rate of silicon included in the molten aluminum alloy L increases because silicon is released into the molten aluminum alloy as the above-described reaction progresses. In this case, the amount of the powder P supplied to the molten aluminum alloy is adjusted such that the final content rate of silicon becomes higher than 12.6 wt %, which is the content rate of silicon at the eutectic point of an aluminum-silicon-based alloy. In such a case, β(Si) particles crystallize in the cooling process of the molten aluminum alloy. Therefore, β (Si) crystal grains crystallize in the base material of the particle-reinforced aluminum composite material.

### Example 1 . . . Confirmation of Shape and Composition of Reinforcing Particles in Particle-Reinforced Aluminum Composite Material

50 kg of an aluminum alloy containing a magnesium component was melted in the storage tank 11 using the manufacturing device 1 shown in FIG. 1 to produce a molten aluminum alloy. The composition of the aluminum alloy used herein is as described below.
Silicon (Si): 6.3 wt %
Magnesium (Mg): 0.4 wt %
Iron (Fe): 0.4 wt %
Copper (Cu): 0.9 wt %
Aluminum (Al): Remainder

Next, the inside of the accommodation container 13 was decompressed to a predetermined low pressure. After that, while maintaining the predetermined low pressure, the powder P composed of a silicon dioxide particle group was charged (injected) into the molten aluminum alloy using the particle supply device 20. The purity of the charged silicon dioxide was 99.5 wt %, the shape was spherical, and the particle diameters were 10 μm or more and 50 μm or less. FIG. 2 shows a SEM image of the charged silicon dioxide particles.

In addition, while charging the powder P composed of the silicon dioxide particle group into the molten aluminum alloy, the molten aluminum alloy was stirred and held at a predetermined temperature (750° C.) for a predetermined time (for example, 120 minutes). As a result, the above-described reduction reaction occurred, and reinforcing particles including a main component represented by MgAl₂O₄ and aluminum were generated in the molten aluminum alloy. In order to compensate for the lack of magnesium caused by the progress of this reduction reaction, solid-form magnesium was appropriately charged into the molten aluminum alloy.

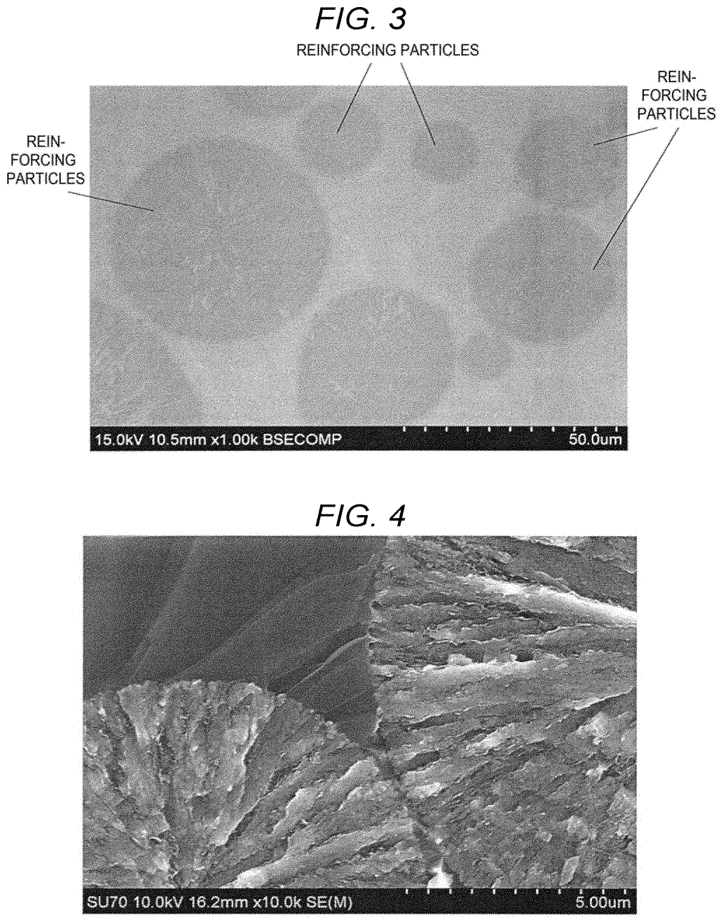

After a predetermined time elapsed, the molten aluminum alloy was poured into a cooling mold, cooled, and solidified. Therefore, a sample S1 of a particle-reinforced aluminum composite material according to Example 1 was produced. The produced sample S1 was cut, and the cross-sectional structure was observed. FIG. 3 and FIG. 4 show SEM images of the cross section of the sample S1. As shown well in FIG. 3, the reinforcing particles are generated in the base material of the aluminum composite material. The shapes of the reinforcing particles are almost spherical, and the diameters thereof are approximately 10 μm to 50 μm. That is, the diameters of the generated reinforcing particles are almost equal to the diameters of the charged silicon dioxide particles. In addition, the interfaces of the reinforcing particles sufficiently adhered to the base material, and there were no gaps between the interfaces of the reinforcing particles and the base material. Therefore, it is considered that defective particles forming gaps between the interfaces of the reinforcing particles and the base material are not formed. In addition, the average particle diameter (median diameter) of the reinforcing particles is 10 μm or more. As described above, the diameters of the generated reinforcing particles are almost equal to the diameters of the charged silicon dioxide particles, and thus it is possible to adjust the average particle diameter of reinforcing particles to be generated to 10 μm or more by adjusting the diameters of silicon dioxide particles to be charged.

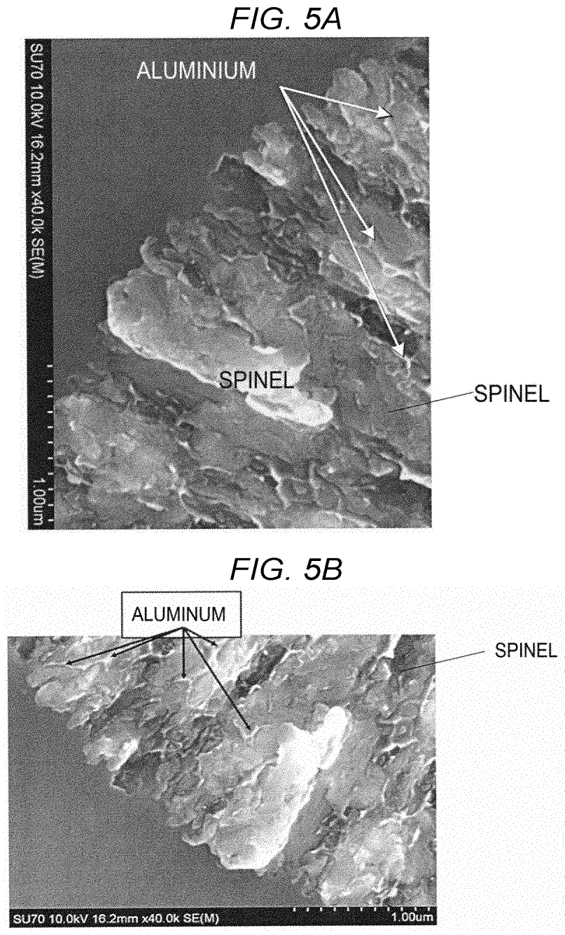

FIG. 5A and FIG. 5B are enlarged SEM images of a part of the reinforcing particles. As shown in FIG. 5A and FIG. 5B, the majority of the reinforcing particles are formed of spinel (MgAl₂O₄). In addition, parts that appear white so as to adhere to the spinel indicate metallic aluminum. As such, it was confirmed that the reinforcing particles produced in the present example had a configuration in which the main component was MgAl₂O₄ and the metallic aluminum was partially mixed.

The above-described generation mechanism of the reinforcing particles, specifically, the mechanism of aluminum being mixed into the reinforcing particles containing MgAl₂O₄ as the main component is not necessarily clear, but can be considered that charging the silicon dioxide particles into the molten aluminum alloy by blowing (driving) the silicon dioxide particles to the molten aluminum alloy in the raw material particle charging step improves the wettability between the silicon dioxide particles and the molten aluminum alloy, and thus the molten aluminum alloy permeates into the particles when the molten aluminum alloy sequentially causes the reduction reaction from all of the surfaces of the silicon dioxide particles.

### Example 2 . . . Investigation of Relationship Between Material Composition of Reinforcing Particles and Particle Hardness

A predetermined amount of pure aluminum (purity: 99.57 wt %) and an aluminum-10 wt % magnesium ingot were put into a 100 cc crucible and mixed together. After that, the mixture was heated to 750° C. and melted in an electric furnace to produce a molten aluminum alloy containing magnesium. In addition, a plurality of molten aluminum alloys having different magnesium concentrations were produced by changing the amount of the pure aluminum and the amount of the aluminum-10 wt % magnesium in a variety of manners as shown in the columns for individual samples S2 to S8 in Table 1. After that, the powder P composed of a silicon dioxide particle group (purity: 99.5 wt %, shape: spherical, particle diameter: 10 μm or more and 50 μm or less) was blown to the respective produced molten aluminum alloys at a predetermined reduced pressure using the particle supply device 20 shown in FIG. 1, thereby charging the powder P into the molten aluminum alloys. In addition, the temperatures of the molten aluminum alloys into which the silicon dioxide particles (powder P) had been charged were held at 750° C. for 10 minutes. After 10 minutes elapsed, the molten aluminum alloys were solidified by natural cooling to produce a plurality of samples S2 to S8 of particle-reinforced aluminum composite materials.

TABLE 1

| | | S2 | S3 | S4 | S5 | S6 | S7 | S8 |
|---|---|---|---|---|---|---|---|---|
| Weight | Pure Al | 121.8 | 107.1 | 85.2 | 80.5 | 84.5 | 89.4 | 84.4 |
| [g] | (99.5 | | | | | | | |
| | wt %) | | | | | | | |
| | Al-10 | 0 | 2.0 | 2.9 | 3.6 | 6.3 | 11.4 | 32.9 |
| | wt % Mg | | | | | | | |

| | | | | | | | |
|---|---|---|---|---|---|---|---|
| Concentration | 0 | 0.18 | 0.33 | 0.43 | 0.69 | 1.13 | 2.8 |
| of Mg [wt %] | | | | | | | |

The concentrations of individual elements forming the reinforcing particles included in each of the produced samples S2 to S8 were calculated using scanning electron microscope/energy dispersive X-ray spectroscopy (SEM/EDX). In addition, the hardness of the reinforcing particles included in each of the samples S2 to S8 was measured with a micro Vickers hardness meter (load: 10 g), and the relationship between the material composition of the reinforcing particles and the hardness was investigated. The hardness of the reinforcing particles in the sample S1 of the particle-reinforced aluminum composite material produced by the method described in Example 1 and the hardness of spinel particles (manufactured by Wako Pure Chemical Industries, Ltd., purity: 99 wt %, particle diameter: 45 μm or less) were also measured together. Table 2 shows the element analysis results and hardness of the reinforcing particles.

TABLE 2

| | Content [wt %] | | | | | | Particle |
|---|---|---|---|---|---|---|---|
| | Element | | | | | | hardness |
| Sample | O | Mg | Al | Si | Fe | Cu | [Hv] |
| S1 | 45.6 | 13.4 | 44.7 | 1.3 | 1.9 | 1.1 | 1367.0 |
| S2 | 40.8 | 0.1 | 58.3 | 0.4 | 0.1 | 0.3 | 1013.9 |
| S3 | 40.1 | 6.8 | 50.2 | 2.6 | 0.1 | 0.1 | 1106.0 |
| S4 | 40.5 | 12.4 | 46.8 | 0.2 | 0.1 | — | 1106.0 |
| S5 | 40.6 | 11.2 | 47.6 | 0.2 | 0.3 | — | 1156.8 |
| S6 | 40.9 | 12.8 | 45.3 | 0.5 | 0.1 | 0.4 | 1211.1 |
| S7 | 41.1 | 13.5 | 44.4 | 0.8 | 0.1 | 0.2 | 1269.5 |
| S8 | 41.6 | 15.5 | 41.7 | 0.7 | 0.4 | 0.1 | 1332.1 |
| Spinel particle | 45.1 | 16.9 | 38.0 | — | — | — | 1682.2 |

In Table 2, the content of magnesium in the reinforcing particles according to the sample S2 is extremely small, and it is considered that MgAl₂O₄ cannot be said to be the main component. Therefore, the sample S2 is not the reinforcing particles according to the embodiment disclosed here. On the other hand, the main components of the reinforcing particles of the samples S1 and S3 to S8 are considered to be MgAl₂O₄. That is, these samples (S1 and S3 to S8) are the particle-reinforced aluminum composite material according to this embodiment disclosed here.

It is found that the hardness of the reinforcing particles included in the samples (S1 and S3 to S8) of the particle-reinforced aluminum composite material according to the present embodiment shown in Table 2 is 1106.0 to 1367.0 [Hv] and is lower than the hardness (1682.2 [Hv]) of spinel particles. Therefore, it is found that the machinability of the particle-reinforced aluminum composite material according to the present embodiment is more favorable than the machinability of the particle-reinforced aluminum composite material containing spinel particles. In addition, it is found that, as the concentration of magnesium in the reinforcing particles increases, and as the concentration of aluminum in the reinforcing particles decreases, the hardness of the reinforcing particles increases. Particularly, it was confirmed that, in a case where the concentration of magnesium in the reinforcing particles is 16 wt % or less, and the concentration of aluminum is 40 wt % or more, the hardness of the reinforcing particles is lower than the hardness of spinel particles. Therefore, it is preferable that, in the reinforcing particles in the particle-reinforced aluminum composite material, the main component is MgAl₂O₄, the concentration of magnesium is 16 wt % or less, and the concentration of aluminum is 40 wt % or more.

In addition, from the results shown in Table 2, it is found that the reinforcing particles included in the particle-reinforced aluminum composite material according to the present embodiment include 40 wt % or more and 50 wt % or less of aluminum, 5 wt % or more and 16 wt % or less of magnesium, 40 wt % or more and 50 wt % or less of oxygen, and an inevitable impurity, and the total mass concentration thereof is 100 wt %.

### Example 3 . . . Investigation of Relationship Between Content Rate and Young's Modulus of Reinforcing Particles Depending on Difference in Concentration of Si in Aluminum Alloy Base Material

In the storage tank 11 of the manufacturing device 1 shown in FIG. 1, 50 kg of an aluminum alloy having the same composition as the composition shown in Example 1 (Al-6.3 wt % Si—0.4 wt % Mg-0.4 wt % Fe-0.9 wt % of Cu) was melted to produce a molten aluminum alloy, and then the inside of the accommodation container 13 was decompressed. Next, the powder P composed of 8.35 kg of a silicon dioxide particle group (SiO₂ purity: 99.5 wt %, spherical shape, particle diameter: 10 μm to 50 μm) was blown to the molten aluminum alloy together with a carrier gas (nitrogen gas) using the particle supply device 20, thereby charging the powder P into the molten aluminum alloy. After that, the molten aluminum alloy was held at a predetermined temperature for a predetermined time, thereby generating reinforcing particles in the molten aluminum alloy. In addition, in order to compensate for the lack of magnesium, a magnesium alloy was appropriately charged into the molten aluminum alloy in the storage tank 11.

Reinforcing particles generated in a molten aluminum alloy tend to settle in the molten aluminum alloy, and thus the content rate (concentration) of the reinforcing particles in the molten aluminum alloy changes depending on the vertical position in the storage tank 11. Using this fact, a part of the molten aluminum alloy was extracted from a plurality of positions present at different vertical positions in the storage tank 11, and the extracted molten aluminum alloy was cooled and solidified, thereby producing a plurality of particle-reinforced aluminum composite materials having different content rates (particle content rates) of the reinforcing particles as samples S9. Immediately before the molten aluminum alloy was removed from the storage tank 11, the concentration of silicon in the molten aluminum alloy was measured using an emission spectroscopic analyzer and found out to be 13.5 wt %. Therefore, the content rate of silicon in the base material of the samples S9 was 13.5 wt %.

In addition, reinforcing particles were generated in the molten aluminum alloy in the same manner as described above by setting the amount of the powder P formed of the silicon dioxide particle group charged into the molten aluminum alloy to 1.4 kg. In addition, a part of the molten aluminum alloy was extracted from a plurality of positions present at different vertical positions in the storage tank 11, and the extracted molten aluminum alloy was cooled and solidified, thereby producing a plurality of particle-reinforced aluminum composite materials having different particle content rates as samples S10. Immediately before the molten aluminum alloy was removed from the storage tank 11, the concentration of silicon in the molten aluminum alloy was measured using an emission spectroscopic analyzer, and the concentration of silicon was found out to be 7.1 wt %. Therefore, the content rate of silicon in the base material of the samples S10 was 7.1 wt %.

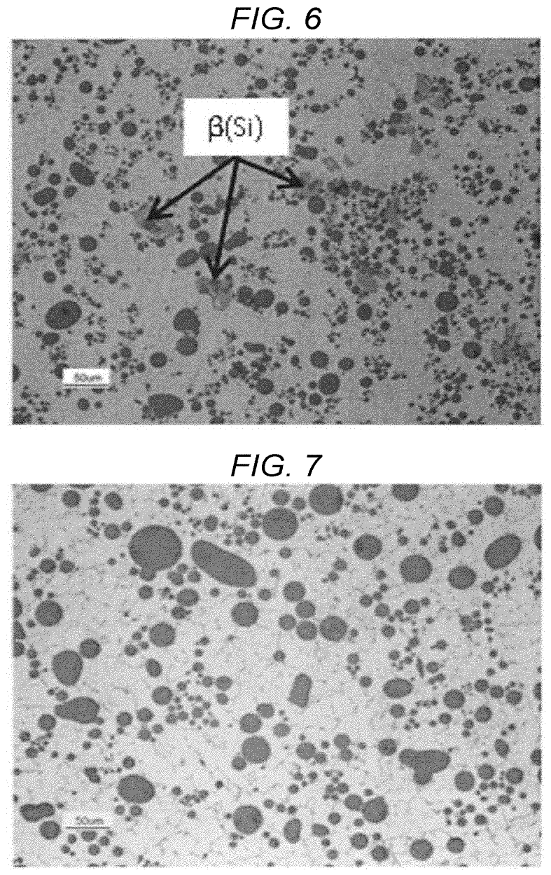

One of the produced samples S9 and one of the samples S10 were cut, and the cut cross sections were observed. FIG. 6 shows a SEM image of the cross section of the sample S9, and FIG. 7 shows a SEM image of the cross section of the sample S10. In FIG. 6, in addition to the reinforcing particles appearing as substantially spherical black parts, structures appearing as gray parts were observed. These structures were analyzed to be β (Si). That is, it was confirmed that, in the sample S9, β (Si) particles crystallized in the base material. On the other hand, in the sample S10 shown in FIG. 7, the reinforcing particles appearing as spherical black parts are shown in the aluminum alloy base material, but structures considered as β (Si) as shown in FIG. 6 do not crystallize.

In the manufacturing of the sample S9, more silicon than the concentration of silicon (12.6 wt %) at the eutectic point of the aluminum-silicon-based alloy was included in the molten aluminum alloy immediately before being cooled. Therefore, it is considered that the β (Si) particles crystallized in the cooling process of the molten aluminum alloy. On the other hand, in the manufacturing of the sample S10, the concentration of silicon contained in the molten aluminum alloy immediately before being cooled was less than the concentration of silicon (12.6 wt %) at the eutectic point of the aluminum-silicon alloy, and thus it is considered that the β (Si) particles did not crystallize in the cooling process of the molten aluminum alloy.

In addition, each of the produced samples S9 was processed to 60 mm×10 mm×t (thickness) 2 mm in order to measure the stiffness (Young's modulus) of the material. In addition, for each of the processed samples S9, the Young's modulus was calculated using an elastic modulus measuring device (manufactured by Nippon Techno-Plus Co., Ltd., JE-RT type). Similarly, each of the produced samples S10 was processed in the same manner as described above, and the Young's modulus was calculated using the same device. In addition, for each of the samples S9 and S10, the relationship between the particle content rate and the Young's modulus was investigated.

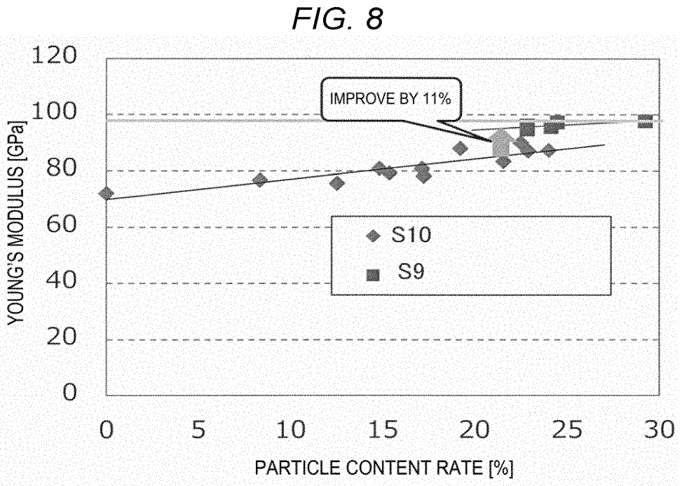

FIG. 8 is a graph showing the relationship between the particle content rate and the Young's modulus for each of the samples S9 and the samples S10. In FIG. 8, the square points are points indicating the relationship between the particle content rate and the Young's modulus for the samples S9, and the rhombic points are points indicating the relationship between the particle content rate and the Young's modulus for the samples S10. As is clear from FIG. 8, it is found that, in the region having a particle content rate of 20% to 25%, the Young's modulus of the sample S9 is higher than the Young's modulus of the sample S10. Specifically, the Young's modulus of the sample S9 improves by approximately 11% compared with the Young's modulus of the sample S10. This is considered to be attributed to the fact that the β (Si) particles crystallize in the base materials of the particle-reinforced aluminum composite materials according to the samples S9 and thus the stiffness of the base materials improves. Therefore, from the viewpoint of improvement in stiffness, the base material preferably contains more than 12.6 wt % of silicon. In addition, the base material preferably includes the β (Si) particles.

### Example 4: Refinement of β (Si) Particles

Crystallized substances including the β (Si) particles crystallized in the aluminum alloy base material described in Example 3 tend to coarsen in a case where the molten aluminum alloy is cooled at an ordinary cooling rate. These crystallized substances that have coarsened have characteristics of being elongated to a small extent, being hard and brittle, and being easily cracked. Therefore, a particle-reinforced aluminum composite material including such a crystallized substance also has a possibility of being elongated to a small extent, being hard and brittle, and being easily cracked. Therefore, in Example 4, an attempt was made to refine the crystallized substance including the β (Si) crystallized in the aluminum alloy base material. In this case, first, a plate-like particle-reinforced aluminum composite material (hereinafter, referred to as the aluminum composite plate) was produced by the same manufacturing method as the manufacturing method of the sample S9 of Example 3. The composition of main components forming the base material in the produced aluminum composite plate was as described below.
Si: 13.5 wt %
Cu: 1.0 wt %
Mg: 0.5 wt %
Al: Remainder

In addition, the particle diameters of the reinforcing particles in the produced aluminum composite plate were 10 μm or more and 50 μm or less, and the particle blending rate was 20% to 25%.

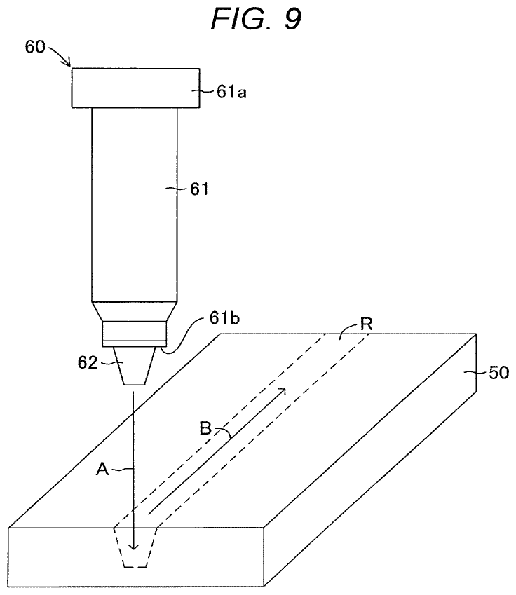

Next, a predetermined region of the produced aluminum composite plate was friction-stirred using a friction stir tool. FIG. 9 is a schematic diagram of the friction stir tool used and the aluminum composite plate being friction-stirred. As shown in FIG. 9, an aluminum composite plate 50 was formed in a plate shape. A long region R surrounded by a broken line in the aluminum composite plate 50 is the predetermined region to be friction-stirred. In addition, a friction stir tool 60 has a tool main body 61 and a probe 62. The tool main body 61 is formed in a stepped cylindrical shape, and one end (upper end in FIG. 9) 61a thereof is connected to a drive source. The tool main body 61 rotates around the axis by driving the drive source. The other end surface of the tool main body 61 configures a shoulder 61b that comes into contact with the surface of a workpiece, and the probe 62 is formed on the shoulder 61b so as to project therefrom. As is clear from FIG. 9, the probe 62 is formed in a tapering truncated cone shape and is connected to the tool main body 61 such that the axial core becomes coaxial with the axial core of the tool main body 61. Therefore, when the drive source is driven, the tool main body 61 and the probe 62 integrally rotate around the axis.

At the time of friction-stirring the aluminum composite plate 50 using the friction stir tool 60, the tip of the probe 62 is moved to press the surface of one end of the predetermined region R of the aluminum composite plate 50 as shown by the arrow A in FIG. 9 while rotating the friction stir tool 60. Therefore, frictional heat is generated by friction between the rotating probe 62 and the surface of the aluminum composite plate 50, and this frictional heat softens the surface of the aluminum composite plate 50. Therefore, the probe 62 moves into the aluminum composite plate 50 so as to be buried therein. After the probe 62 is moved into the aluminum composite plate 50 until the shoulder 61b of the friction stir tool 60 comes into contact with the surface of the aluminum composite plate 50, the friction stir tool 60 is horizontally moved in the longitudinal direction of the predetermined region R as shown by the arrow B in FIG. 9 while being rotated. Therefore, the structure in the predetermined region R is friction-stirred with the probe 62. In the present example, the friction stir was carried out by setting the rotation speed of the friction stir tool to 1000 rpm and setting the feed speed (moving speed) in the horizontal direction to 200 mm/min.

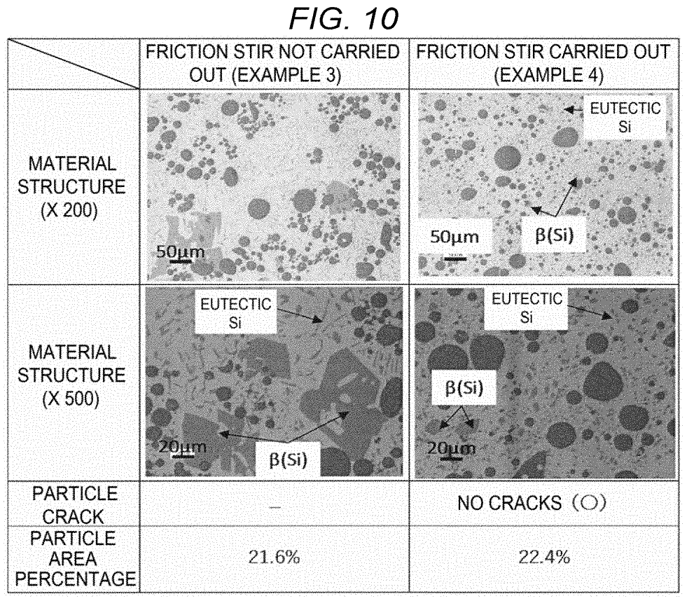

After the friction stir was carried out, a part of the friction-stirred predetermined region R (hereinafter, referred to as the modified layer) was cut and removed. The cut surface of the removed modified layer was polished, and the structure on the polished surface was observed with a metallographic microscope. FIG. 10 shows photographic images of the cross section of the structure observed with the metallographic microscope as Example 4. FIG. 10 also shows, for reference, photographic images obtained by observing the cross section of the structure of a part on which the friction stir was not carried out (a non-modified layer part in the aluminum composite plate 50) with the metallographic microscope as Example 3.

As shown in FIG. 10, in both a case where the friction stir is carried out (Example 4) and a case where the friction stir is not carried out (Example 3), the aluminum alloy base material includes the β (Si) particles and eutectic Si particles. When the concentration of Si included in the molten aluminum alloy is the eutectic point (12.6 wt %) or less, the eutectic Si particles crystallize in the cooling process of the molten alloy, but the β (Si) particles do not crystallize. On the other hand, when the concentration of Si included in the molten aluminum alloy exceeds the eutectic point, as described above, the β (Si) particles crystallize, and the eutectic Si particles also crystallize. The β (Si) particles crystallize in a massive form, and the eutectic Si particles crystallize in a needle shape. In addition, the particle area percentage in the photographic image according to Example 4 (the proportion of the area of particles (reinforcing particles) in the area of the entire aluminum alloy in the photographic image) was 22.4%, and the particle area percentage in the photographic image according to Example 3 was 21.6%. From this fact, it is found that the particle area percentage does not significantly change before and after the friction stir is carried out.

In addition, as is clear from the comparison between the photographic image according to Example 3 in which the friction stir was not carried out and the photographic image according to Example 4 in which the friction stir was carried out, the sizes of the β (Si) particles and the eutectic Si particles included in the aluminum alloy base material according to Example 4 are smaller than the sizes of the β (Si) particles and the eutectic Si particles included in the aluminum alloy base material according to Example 3 in which the friction stir was not carried out. On the other hand, the sizes of the reinforcing particles in the aluminum alloy base material according to Example 4 do not significantly differ from the sizes of the reinforcing particles in the aluminum alloy base material according to Example 3 in which the friction stir was not carried out. From this fact, it is found that friction stir is capable of refining the β (Si) particles and the eutectic Si particles without significantly changing the diameters of the reinforcing particles. In other words, it is found that friction stir is capable of refining the crystallized substance including the β (Si) particles crystallized in the cooling process of the molten aluminum alloy without causing the cracking or the like of the reinforcing particles. When friction stir is carried out on a particle-reinforced aluminum composite material in which the reinforcing particles are spinel particles, the spinel particles are highly likely to crack. Therefore, when friction stir is carried out on the particle-reinforced aluminum composite material containing the reinforcing particles according to the present embodiment, it becomes possible to refine the crystallized substance without cracking the reinforcing particles. In addition, as a result of observing the photographic image according to Example 4, no particle defects such as the cracking (chipping) of the β (Si) particles were found. From this fact, it is found that friction stir is capable of refining the β (Si) particles without causing cracking.

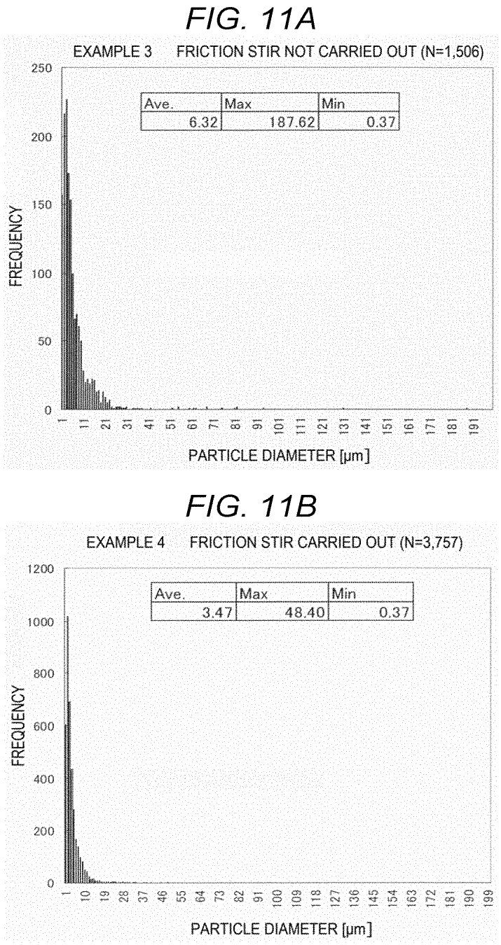

In addition, the particle size distributions of the crystallized substances including the β (Si) particles crystallized in the aluminum alloy base material were investigated from the photographic image according to Example 3 and the photographic image according to Example 4 captured using image analysis software. FIG. 11A shows the particle size distribution measurement result of the crystallized substance according to Example 3, and FIG. 11B shows the particle size distribution measurement result of the crystallized substance according to Example 4. The measurement results of the particle size distributions shown in FIGS. 11A and 11B show that the average particle diameter (median diameter) of the crystallized substance according to Example 3 was 6.32 μm and the maximum particle diameter was 187.62 μm. On the other hand, the average particle diameter (median diameter) of the crystallized substance according to Example 4 was 3.47 μm, and the maximum particle diameter was 48.40 μm. From this fact, it is found that the crystallized substance was refined by the friction stir. In a case where the shapes of the particles had different diameters in the measurement of the particle size distribution, the maximum diameter or the maximum length was measured as the particle diameter.

<Measurement of Tensile Strength and Elongation>

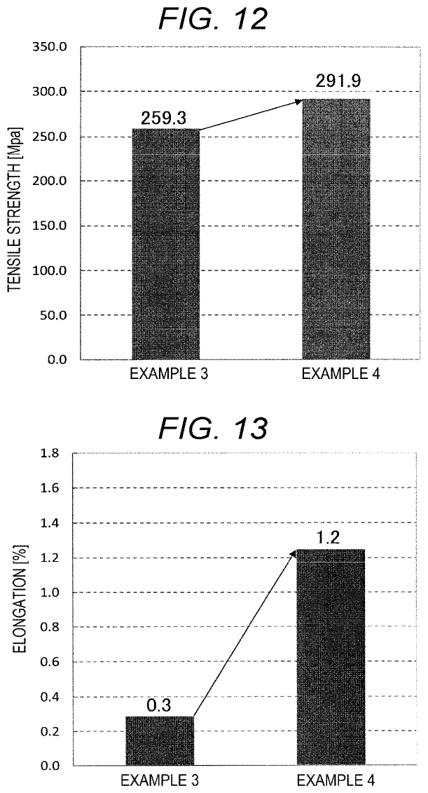

Tensile test pieces (JIS Z2241 No. 14A) were cut out respectively from the modified layer on which the friction stir was carried out according to Example 4 and the part (the non-modified layer part in the aluminum composite plate 50) according to Example 3 on which the friction stir was not carried out, tensile tests were carried out using an AUTOGRAPH (manufactured by Shimadzu Corporation: AG-X (100 kN)), and the tensile strengths and the amounts of elongation until the test piece fractured were measured. FIG. 12 shows the tensile test results, and FIG. 13 shows the measurement results of the amounts of elongation.

As is clear from FIG. 12 and FIG. 13, the tensile strength and the amount of elongation of the tensile test piece according to Example 4 are larger than the tensile strength and the amount of elongation of the tensile test piece according to Example 3. Specifically, the tensile strength (291.9 MPa) of the tensile test piece according to Example 4 improves by 13% relative to the tensile strength (259.3 MPa) of the tensile test piece according to Example 3, and the amount of elongation (1.2%) of the tensile test piece according to Example 4 is approximately 4 times the amount of elongation (0.3%) of the tensile test piece of Example 3. From this fact, it is found that, when the crystallized substance including the β (Si) particles crystallized in the aluminum alloy base material (specifically, the β (Si) particles and the eutectic Si particles) is refined by friction stir, the tensile strength and the ductility improve. Particularly, in a case where the average particle diameter (median diameter) of the crystallized substance including the β (Si) particles crystallized in the aluminum alloy base material is 5 μm or less and more preferably 3.5 μm or less, and in a case where the maximum particle diameter of the crystallized substance including the β (Si) particles crystallized in the aluminum alloy base material is 50 μm or less, the tensile strength and ductility of the particle-reinforced aluminum composite material improve.

### Example 5: Confirmation of Influence of Heat Treatment on Tensile Strength and Elongation

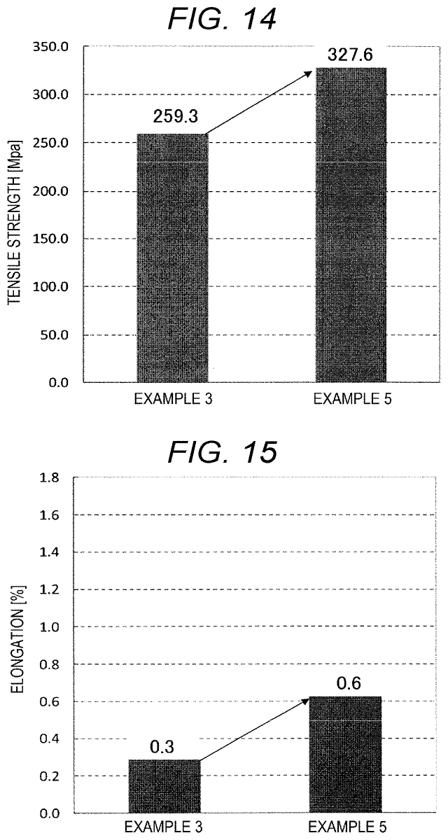

The modified layer according to Example 4 was cut out, and a heat treatment (T6 treatment) was carried out thereon, thereby producing a modified layer according to Example 5. A tensile test piece (JIS Z2241 No. 14A) was cut out from the produced modified layer according to Example 5, a tensile test was carried out using an AUTOGRAPH (manufactured by Shimadzu Corporation: AG-X (100 kN)), and the tensile strength and the amount of elongation of the tensile test piece according to Example 5 were measured. FIG. 14 shows the tensile test result, and FIG. 15 shows the measurement result of the amount of elongation. For reference, FIG. 14 also shows the tensile strength of the tensile test piece according to Example 3, and FIG. 15 also shows the amount of elongation of the tensile test piece according to Example 3.

As is clear from FIG. 14, the tensile strength (327.6 MPa) of the tensile test piece according to Example 5 is higher than the tensile strength (259.3 MPa) of the tensile test piece according to Example 3. Specifically, the tensile strength of the tensile test piece according to Example 5 in which the heat treatment was carried out on the modified layer improves by 26% relative to the tensile strength of the tensile test piece according to Example 3. On the other hand, as is clear from FIG. 15, the amount of elongation (0.6%) of the tensile test piece according to Example 5 in which the heat treatment was carried out on the modified layer is approximately twice the amount of elongation (0.3%) of the tensile test piece according to Example 3.

In addition, as is clear from the comparison between FIG. 12 and FIG. 14, in a case where the heat treatment is carried out on the modified layer (in the case of Example 5), the tensile strength further improves compared with a case where the heat treatment is not carried out (in the case of Example 4). On the other hand, as is clear from the comparison between FIG. 13 and FIG. 15, in a case where the heat treatment is carried out on the modified layer (in the case of Example 5), the amount of elongation decreases compared with a case where the heat treatment is not carried out (in the case of Example 4). Therefore, in a case where the particle-reinforced aluminum composite material is applied to a member requiring a higher tensile strength, it is preferable to carry out a heat treatment on the modified layer. On the other hand, in a case where the particle-reinforced aluminum composite material is applied to a member requiring a larger amount of elongation (ductility), it is preferable not to carry out a heat treatment on the modified layer.

### Example 6: Application to Pressure-Resistant Component

The particle-reinforced aluminum composite material described in the present embodiment can be applied to a pressure-resistant component that is imparted with a predetermined pressure and has a strength high enough to withstand the imparted pressure. In this case, it is possible to increase the strength of the pressure-resistant component and also improve the machinability.

Particularly, as the particle-reinforced aluminum composite material according to the present embodiment, a particle-reinforced aluminum composite material containing the β (Si) particles in the aluminum alloy base material is preferably used for the pressure-resistant component. That is, the pressure-resistant component is preferably formed of a particle-reinforced aluminum composite material including a base material formed of an aluminum alloy and reinforcing particles dispersed in the base material, and the reinforcing particles preferably include a main component represented by MgAl₂O₄ and aluminum, and the base material preferably includes a crystallized substance including the β (Si) particles. When the pressure-resistant component is configured as described above, the strength can be increased, the machinability is favorable, and it is possible to improve the stiffness.

In addition, in a case where the pressure-resistant component has a stress-concentrated region in which stress is concentrated by an imparted pressure, the size of a crystallized substance including the β (Si) particles included in the aluminum alloy base material, which forms the stress-concentrated region, is preferably smaller than the size of the crystallized substance including the β (Si) particles included in the aluminum alloy base material, which forms a region other than the stress-concentrated region. That is, it is preferable to refine the crystallized substance in the stress-concentrated region. In this case, when the crystallized substance is refined such that the average particle diameter (median diameter) of the crystallized substance including the β (Si) included in the aluminum alloy base material, which forms the stress-concentrated region, is 5 μm or less and the maximum particle diameter is 50 μm or less, the tensile strength and ductility of the stress-concentrated region are further increased. Therefore, the stress-concentrated region being fractured by stress is effectively suppressed, and, furthermore, it is possible to further improve the durability (pressure-resistant characteristic) of the pressure-resistant component.

As such a pressure-resistant component, preferably, a caliper body used in a vehicle brake device can be exemplified.

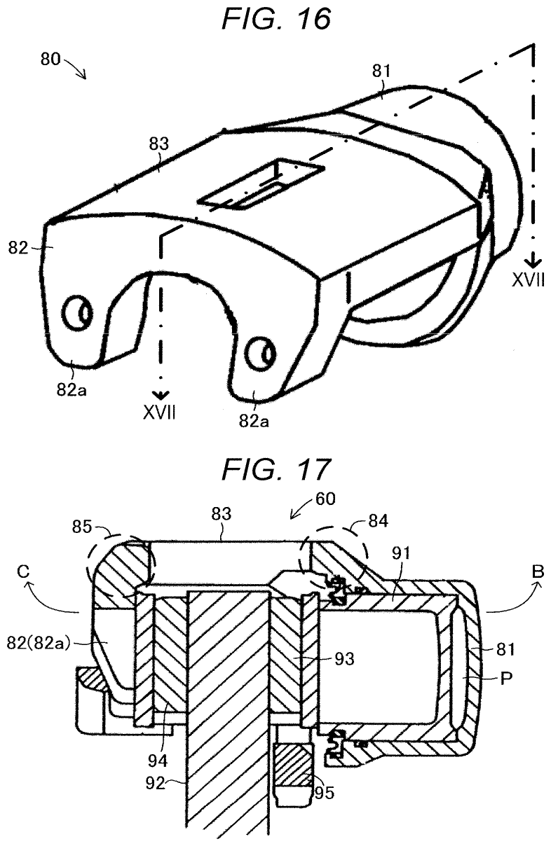

FIG. 16 is a schematic view of a caliper body. In addition, FIG. 17 is a schematic cross-sectional view of a brake device into which the caliper body of FIG. 16 is assembled. The cross section of the caliper body shown in FIG. 17 is a cross section of the caliper body of FIG. 16 taken along the line XVII-XVII.

As shown in FIG. 16 and FIG. 17, a caliper body 80 has a cylinder portion 81, a facing portion 82, and a coupling portion 83. These portions are integrally molded. The cylinder portion 81 is formed in a cylindrical shape so as to form a cylindrical space for accommodating a piston 91 therein, one end is opened, and the other end is closed. In addition, the piston 91 is mounted in the inside of the cylinder portion 81 from the opened one end. The piston 91 is accommodated in the cylinder portion 81 so as to be movable in the axial direction. At this time, a fluid pressure chamber P is formed in a liquid-tight manner between the bottom surface of the piston 91 and the other end surface of the cylinder portion 81.

In addition, the coupling portion 83 is extended away from the cylinder portion 81 along the axial direction of the cylinder portion 81 from a predetermined region configuring the upper part of the opening edge at one end of the cylinder portion 81 in FIG. 16 and FIG. 17. A pair of reaction force arms 82a and 82b are provided so as to extend downward in FIG. 16 and FIG. 17 from the extension end of the coupling portion 83. The pair of reaction force arms 82a and 82b configure the facing portion 82. As described above, the coupling portion 83 couples the cylinder portion 81 and the facing portion 82. In addition, the pair of reaction force arms 82a and 82b (facing portion 82) are disposed to face the open surface of the cylinder portion 81 in the moving direction (axial direction) of the piston 91.

As shown in FIG. 17, when the caliper body 80 is assembled to a brake device, a part of a disc rotor 92 attached to a vehicle is disposed between the cylinder portion 81 and the facing portion 82 that are disposed to face each other. Therefore, the cylinder portion 81 and the facing portion 82 face each other across the disc rotor 92, and the coupling portion 83 is disposed so as to astride the outer circumference of the disc rotor 92.

An inner pad 93 is disposed between the open surface of the piston 91 in the cylinder portion 81 and the disc rotor 92, and an outer pad 94 is disposed between the facing portion 82 and the disc rotor 92. The inner pad 93 and the outer pad 94 are supported by a mounting 95, which is a configurational component of the brake device. In addition, the caliper body 80 is supported by the mounting 95 through a slide pin, not shown, so as to be movable in the axial direction of the cylinder portion 81 (the axial direction of the piston 91).

In such a brake device, when the driver presses the brake pedal while driving the vehicle (while the disc rotor 92 is rotating), the fluid pressure in the fluid pressure chamber P increases, and thus the piston 91 moves leftward in FIG. 17. Then, the inner pad 93 also moves leftward due to the movement of the piston 91 and presses the disc rotor 92. On the other hand, as the fluid pressure in the fluid pressure chamber P increases, the caliper body 80 moves rightward in FIG. 17. Then, this movement is transmitted from the facing portion 82 (reaction force arm 82a) of the caliper body 80 to the outer pad 94, and the outer pad 94 moves rightward in FIG. 17 and presses the disc rotor 92. In the above-described manner, the inner pad 93 and the outer pad 94 press the disc rotor 92 from both sides of the disc rotor. The pressing force acts on the disc rotor 92 as a frictional force, whereby the disc rotor 92 is braked.

In the above-described brake operation process, the fluid pressure in the fluid pressure chamber P directly acts on the cylinder portion 81 of the caliper body 80. Due to this fluid pressure, stress acts on the cylinder portion 81 in the direction of the arrow B in FIG. 17. That is, stress acts such that the cylinder portion 81 opens. In addition, a reaction force from the outer pad 94 acts on the facing portion 82. Due to this reaction force, stress acts on the facing portion 82 in the direction of the arrow C in FIG. 17. That is, stress acts such that the facing portion 82 opens.

The stress acting in the direction of the arrow B concentrates stress in a boundary part 84 between the cylinder portion 81 and the coupling portion 83. In addition, the stress acting in the direction of the arrow C concentrates stress in a boundary part 85 between the facing portion 82 and the coupling portion 83. That is, the boundary part 84 and the boundary part 85 are stress-concentrated regions.

As described above, the fluid pressure and the stress generated by the reaction force based on the fluid pressure act on the caliper body 80. The caliper body 80 is designed to withstand this stress. That is, the caliper body 80 is a pressure-resistant component. When the caliper body 80, which is such a pressure-resistant component, is formed of the particle-reinforced aluminum composite material described in the above-described embodiment, it is possible to improve the pressure-resistance performance. Particularly, the caliper body 80 is preferably formed of, as the particle-reinforced aluminum composite material described in the present embodiment, a particle-reinforced aluminum composite material in which the aluminum alloy base material includes the β (Si) particles. Specifically, it is preferable that the caliper body 80 is formed of a particle-reinforced aluminum composite material including a base material formed of an aluminum alloy and reinforcing particles dispersed in the base material, in which the reinforcing particles include a main component represented by MgAl₂O₄ and aluminum, and the base material includes a crystallized substance including the β (Si) particles. When the caliper body 80 is configured as described above, it is also possible to improve the Young's modulus (stiffness).

In addition, the caliper body 80 has the boundary parts 84 and 85 in which acting stress concentrates. The size of the crystallized substance including the β (Si) particles crystallized in the aluminum alloy base material of the particle-reinforced aluminum composite material, which forms the boundary parts 84 and 85, is preferably smaller than the size of the crystallized substance including the β (Si) particles crystallized in the aluminum alloy base material of the particle-reinforced aluminum composite material, which forms a part other than the boundary parts 84 and 85. That is, it is preferable that the crystallized substance including the β (Si) particles crystallized in the aluminum alloy base material, which forms the boundary parts 84 and 85, is refined. In this case, when the average particle diameter (median diameter) of the crystallized substance including the β (Si) particles in the aluminum alloy base material, which forms the boundary parts 84 and 85, is set to 5 μm or less (preferably 3.5 μm or less), and the maximum particle diameter is set to 50 μm or less, the tensile strength and ductility of the boundary parts 84 and 85 further improve. When the strength of the boundary parts 84 and 85 is further increased in the above-described manner, the tensile strength and ductility of the boundary parts 84 and 85 are increased, and thus the durability of the caliper body 80 can be further improved.

In this case, the caliper body 80 (pressure-resistant component) can be manufactured by a manufacturing method including the raw material particle charging step described above, the reinforcing particle generation step described above, a molding step, and a refining step. Here, the molding step is a step of cooling the molten aluminum alloy after the reinforcing particle generation step to crystallize the crystallized substance including the β (Si) particles in the aluminum alloy base material and solidifying the molten aluminum alloy to mold (for example, casting molding) the caliper body 80 (pressure-resistant component). The refining step is a step of friction-stirring the boundary parts 84 and 85 (stress-concentrated regions) of the molded caliper body 80 (pressure-resistant component) to refine the crystallized substance including the β (Si) particles crystallized in the aluminum alloy base material, which forms the boundary parts 84 and 85 (stress-concentrated regions), to an average particle diameter of 5 μm or less and a maximum particle diameter of 50 μm or less. In this refining step, specifically, after the caliper body 80 is molded (for example, casting molding) of the aluminum composite material described in the present embodiment, the probe 62 is moved into the boundary parts 84 and 85 by rotating and pressing the friction stir tool 60 described in the above-described embodiment from the inner surfaces (surfaces facing the disc rotor 92) of the boundary part 84 and the boundary part 85, and the friction stir tool 60 is moved such that the probe 62 passes through the entire region or a predetermined region of the boundary parts 84 and 85 in this state. As a result, the boundary parts 84 and 85 are friction-stirred, whereby it is possible to refine the β (Si) particles and the eutectic Si particles in the aluminum alloy base material, which forms the boundary parts 84 and 85, to an average particle diameter (median diameter) of 5 μm or less and a maximum particle diameter of 50 μm or less.

For information, as means for refining the crystallized substance including the β (Si) particles crystallized in the aluminum alloy base material, additionally, means for adding an additive to the molten aluminum alloy can be considered. However, in this case, the crystallized substance is refined throughout the entire molded product. In contrast, when the above-described method, that is, the method in which, after the molding of a product (pressure-resistant component) (for example, after casting), a specific region is friction-stirred to refine the crystallized substances present in the region is employed, it is possible to refine the crystallized substance only in the specific region of the molded product. Therefore, this method is useful as means for refining the crystallized substance only in a part requiring tensile strength or ductility, that is, a stress-concentrated region.

In the above-described example, a floating-type caliper body has been exemplified using the caliper body 80 as the pressure-resistant component, but the embodiments disclosed here can also be applied to an opposed-type caliper body. In this case, the facing portion becomes the cylinder portion, and the boundary parts become the boundary parts between both cylinder portions and the coupling portion.

An aspect of this disclosure provides a particle-reinforced aluminum composite material including a base material formed of an aluminum alloy and reinforcing particles dispersed in the base material, in which the reinforcing particles include a main component represented by MgAl₂O₄ and aluminum. In this case, aluminum in the reinforcing particles are preferably mixed into the reinforcing particles so as to adhere to the main component.

According to the aspect of this disclosure, the reinforcing particles include metallic aluminum in addition to spinel (MgAl₂O₄), which is the main component. The hardness of metallic aluminum is lower than the hardness of spinel. Therefore, the decoupling property of the reinforcing particles according to the aspect of this disclosure improves, and, consequently, it is possible to improve the machinability of the particle-reinforced aluminum composite material. In addition, the main component of the reinforcing particles dispersed in the base material is spinel (MgAl₂O₄), and thus the mechanical strength is ensured to a certain extent. That is, according to the aspect of this disclosure, it is possible to provide a particle-reinforced aluminum composite material having machinability improved without significantly decreasing the mechanical strength compared with a particle-reinforced aluminum composite material including spinel particles.

In this case, the reinforcing particles may preferably include 40 wt % or more of aluminum. More preferably, the reinforcing particles may include 40 wt % or more of aluminum and 16 wt % or less of magnesium. Still more preferably, the reinforcing particles may include 40 wt % or more and 50 wt % or less of aluminum and 5 wt % or more and 16 wt % or less of magnesium. Further preferably, the reinforcing particles may include 40 wt % or more and 50 wt % or less of aluminum, 5 wt % or more and 16 wt % or less of magnesium, 40 wt % or more and 50 wt % or less of oxygen, and an inevitable impurity, and a total mass concentration thereof may be 100 wt %.

In addition, the base material may preferably include silicon of more than 12.6 wt % and 20 wt % or less. Alternatively, the base material may preferably include a crystallized substance including β (Si) particles. Here, the β (Si) particles refer to silicon particles that crystallize in an Al—Si-based molten alloy having a higher content rate of silicon than the content rate of silicon (12.6 wt %) at the eutectic point of aluminum and silicon in a process of cooling the molten alloy, but do not crystallize in a process of cooling an Al—Si-based molten alloy having the above-described content rate or less. When the particle-reinforced aluminum composite material according to the aspect of this disclosure is molded by cooling a molten aluminum alloy including more than 12.6 wt % silicon, the β (Si) particles crystallize in the base material. These β (Si) particles enhance the stiffness of the base material. Therefore, it is possible to enhance the stiffness of the particle-reinforced aluminum composite material.

In addition, an average particle diameter (median diameter) of the reinforcing particles may preferably be 10 μm or more. According to this, the particle diameter of the reinforcing particles is much larger than the average particle diameter (approximately 0.2 μm) of the reinforcing particles described in JP 2007-291450A, and thus it is possible to enhance the wear resistance of the aluminum composite material.

In addition, the crystallized substance including the β (Si) particles included in the base material may preferably have at least any particle diameter of an average particle diameter (median diameter) of 5 μm or less or a maximum particle diameter of 50 μm or less. In a case where the average particle diameter (median diameter) of the crystallized substance including the β (Si) particles included in the base material is 5 μm or less or the maximum particle diameter is 50 μm or less, that is, in a case where the crystallized substance in the base material is refined, it is possible to enhance the tensile strength and ductility of the aluminum composite material.

Another aspect of this disclosure provides a pressure-resistant component which is imparted with a predetermined pressure and has a strength high enough to withstand the imparted pressure, in which the pressure-resistant component is formed of a particle-reinforced aluminum composite material including a base material formed of an aluminum alloy and reinforcing particles dispersed in the base material, and the reinforcing particles include a main component represented by MgAl₂O₄ and aluminum, and the base material includes a crystallized substance including β (Si) particles.

According to the above-described configuration, it is possible to provide a pressure-resistant component having a high mechanical strength, favorable machinability, and high stiffness.

In this case, the pressure-resistant component may preferably have a stress-concentrated region in which stress is concentrated by the imparted pressure, and a size of the crystallized substance included in the base material, which forms the stress-concentrated region, may be smaller than a size of the crystallized substance included in the base material, which forms a region other than the stress-concentrated region.

Furthermore, in this case, the average particle diameter (median diameter) of the crystallized substance included in the base material, which forms the stress-concentrated region, may preferably be 5 μm or less and the maximum particle diameter may be 50 μm or less.

According to this, the crystallized substance including the 6 (Si) particles included in the aluminum alloy base material, which forms the stress-concentrated region in the pressure-resistant component, is refined, and thus the tensile strength and ductility of the stress-concentrated region improve, and, consequently, it is possible to further improve the pressure-resistant characteristic of the pressure-resistant component.

The pressure-resistant component may be a caliper body constituting a brake device configured to be mounted in a vehicle. In this case, the caliper body may preferably have a cylinder portion configured to accommodate a piston so as to be movable in an axial direction, a facing portion disposed to be apart from the cylinder portion in a moving direction of the piston and to face the cylinder portion, and a coupling portion configured to couple the cylinder portion and the facing portion, and the stress-concentrated region may preferably be at least one of a boundary part between the cylinder portion and the coupling portion and a boundary part between the facing portion and the coupling portion.

The caliper body constituting the brake device receives stress when the piston moves in the axial direction by a fluid pressure and presses a brake pad against a disc rotor. This stress tends to concentrate in the boundary part between the cylinder portion and the coupling portion of the caliper body and in the boundary part between the facing portion and the coupling portion. Therefore, when the crystallized substance in the aluminum alloy base material, which forms the boundary part in which the stress concentrates in the above-described manner, is refined, the tensile strength and ductility of the boundary parts improve, and fracturing in the boundary part is suppressed. Therefore, the durability of the caliper body improves.

Still another aspect of this disclosure provides a method for manufacturing a pressure-resistant component which is imparted with a predetermined pressure, has a strength high enough to withstand the imparted pressure, and has a stress-concentrated region in which stress is concentrated by the imparted pressure, the method including a raw material particle charging step of charging powder composed of silicon dioxide particles into a molten aluminum alloy including magnesium, a reinforcing particle generation step of reacting the silicon dioxide particles charged into the molten aluminum alloy in the raw material particle charging step with magnesium and aluminum, which are components of the molten aluminum alloy, to generate reinforcing particles including a main component represented by MgAl₂O₄ and aluminum, a molding step of cooling the molten aluminum alloy to crystallize a crystallized substance including 13 (Si) particles in an aluminum alloy base material and solidifying the molten aluminum alloy to form a pressure-resistant component, and a refining step of friction-stirring the stress-concentrated region in the molded pressure-resistant component to refine the crystallized substance crystallized in the aluminum alloy base material, which forms the stress-concentrated region, to have an average particle diameter of 5 μm or less and a maximum particle diameter of 50 μm or less.

According to this configuration, it is possible to manufacture a pressure-resistant component having a high mechanical strength, favorable machinability, and a high Young's modulus (stiffness). In addition, the tensile strength and ductility of the stress-concentrated region improve, and, consequently, it is possible to further improve the pressure-resistant characteristic of the pressure-resistant component.

Hitherto, the embodiment disclosed here has been described, but the embodiments disclosed here are not limited to the above-described embodiment. For example, in the above-described embodiment, the caliper body 80 has been described as the pressure-resistant component, but the embodiments disclosed here can also be applied to other pressure-resistant components. The embodiments disclosed here can be modified within the scope of the gist.

The principles, preferred embodiment and mode of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A particle-reinforced aluminum composite material comprising:
a base material formed of an aluminum alloy; and
reinforcing particles dispersed in the base material, wherein
the reinforcing particles include
a main component represented by MgAl₂O₄ and
aluminum.

2. The particle-reinforced aluminum composite material according to claim 1, wherein the reinforcing particles include 40 wt % or more of aluminum.

3. The particle-reinforced aluminum composite material according to claim 1, wherein the reinforcing particles include
40 wt % or more of aluminum, and
16 wt % or less of magnesium.

4. The particle-reinforced aluminum composite material according to claim 1, wherein the base material includes silicon of more than 12.6 wt % and 20 wt % or less.

5. The particle-reinforced aluminum composite material according to claim 1, wherein the base material includes a crystallized substance including β (Si) particles.

6. The particle-reinforced aluminum composite material according to claim 1, wherein an average particle diameter of the reinforcing particles is 10 μm or more.

7. The particle-reinforced aluminum composite material according to claim 5, wherein
the crystallized substance including the β (Si) particles has at least any particle diameter of an average particle diameter of 5 μm or less or a maximum particle diameter of 50 μm or less.

8. A pressure-resistant component imparted with a predetermined pressure and having a strength high enough to withstand the imparted pressure, wherein
the pressure-resistant component is formed of a particle-reinforced aluminum composite material including a base material formed of an aluminum alloy and reinforcing particles dispersed in the base material, and
the reinforcing particles include a main component represented by MgAl₂O₄ and aluminum, and the base material includes a crystallized substance including β (Si) particles.

9. The pressure-resistant component according to claim 8, wherein
the pressure-resistant component has stress-concentrated region in which stress is concentrated by the imparted pressure, and
a size of the crystallized substance included in the base material, which forms the stress-concentrated region, is smaller than a size of the crystallized substance included in the base material, which forms a region other than the stress-concentrated region.

10. The pressure-resistant component according to claim 9, wherein
the pressure-resistant component is a caliper body constituting a brake device configured to be mounted in a vehicle,
the caliper body has
a cylinder portion configured to accommodate a piston so as to be movable in an axial direction,
a facing portion disposed to be apart from the cylinder portion in a moving direction of the piston and to face the cylinder portion, and
a coupling portion configured to couple the cylinder portion and the facing portion, and
the stress-concentrated region is at least one of a boundary part between the cylinder portion and the coupling portion and a boundary part between the facing portion and the coupling portion.

11. A method for manufacturing a pressure-resistant component which is imparted with a predetermined pressure, has a strength high enough to withstand the imparted pressure, and has a stress-concentrated region in which stress is concentrated by the imparted pressure, the method comprising:
a raw material particle charging step of charging powder composed of silicon dioxide particles into a molten aluminum alloy including magnesium;
a reinforcing particle generation step of reacting the silicon dioxide particles charged into the molten aluminum alloy in the raw material particle charging step with magnesium and aluminum, which are components of the molten aluminum alloy, to generate reinforcing particles including a main component represented by MgAl₂O₄ and aluminum;
a molding step of cooling the molten aluminum alloy to crystallize a crystallized substance including β (Si) particles in an aluminum alloy base material and solidifying the molten aluminum alloy to form a pressure-resistant component; and
a refining step of friction-stirring the stress-concentrated region in the molded pressure-resistant component to refine the crystallized substance crystallized in the aluminum alloy base material, which forms the stress-concentrated region, to have an average particle diameter of 5 μm or less and a maximum particle diameter of 50 μm or less.
